(19) United States
(12) Patent Application Publication
(10) Pub. No.: US 2018/0348025 A1
(43) Pub. Date: Dec. 6, 2018

(54) PROGRAMMABLE ELASTIC METAMATERIALS

(71) Applicant: Northeastern University, Boston, MA (US)

(72) Inventors: Babak Haghpanah Jahromi, Irvine, CA (US); Ashkan Vaziri, Cambridge, MA (US)

(21) Appl. No.: 15/562,327

(22) PCT Filed: Apr. 15, 2016
(86) PCT No.: PCT/US2016/027786

§ 371 Date: Sep. 27, 2017

Related U.S. Application Data
(60) Provisional application No. 62/147,969, filed on Apr. 15, 2015.

(51) Int. Cl. G01D 21/00; F03G 7/06

(52) U.S. Cl. CPC G01D 21/00; F03G 7/065

(57) ABSTRACT

Embodiments of the present invention provide programmable materials capable of real-time, significant adjustment in their mechanical response. When combined with autonomous sensing and control strategies, these materials can be used in a new series of structural components with enhanced static and dynamic efficiency. An embodiment of the present invention provides an apparatus comprising an array of one or more unit cells, formed from a material, each cell defining a shape; and links coupled to the unit cells, at least a subset of the links enabling changing of an elasticity of at least a subset of the unit cells or at least a sub- array of the unit cells as a function of a state of the at least a subset of the links, the state including ON and OFF states.

### RELATED APPLICATION

This application claims the benefit of U.S. Provisional Application No. 62/147,969, filed on Apr. 15, 2015. The entire teachings of the above application(s) are incorporated herein by reference.

### GOVERNMENT SUPPORT

This invention was made with government support under Grant No. CMMI 1149750 from The National Science Foundation. The government has certain rights in the invention.

### BACKGROUND

In the field of elastic metamaterials, materials may be tuned for use in a variety of applications.

### SUMMARY OF THE INVENTION

A first embodiment of the invention provides an apparatus comprising an array of one or more unit cells, formed from a material, each cell defining a shape; and links coupled to the unit cells, at least a subset of the links enabling changing of an elasticity of at least a subset of the unit cells or at least a sub-array of the unit cells as a function of a state of the at least a subset of the links, the state including ON and OFF states.

In an aspect of the first embodiment, the shape is a geometrical shape selected from two- or three-dimensional shapes that include at least one of a circle, sphere, oval, ellipse, ellipsoid, triangle, kagome, tetrahedron, pyramid, cone, square, cube, rectangle, cuboid, cylinder, rhombus, trapezoid, pentagon, hexagon, heptagon, octagon, octahedron, dodecahedron, or octet.

In another aspect of the first embodiment, the material is one or more materials selected from polymers, plastics, ceramics, metals, metal oxides, metal alloys, cellular materials, foams, carbon fiber, biomaterials, or composites thereof.

In another aspect of the first embodiment, a given link is an intra-connectivity coupled to at least two locations within a corresponding unit cell of the at least a subset of the unit cells; or a given link is an inter-connectivity between or among unit cells within the at least a sub-array of the unit cells; and wherein: a given link is fixed or switchable; and a given link is defined as an intra-connectivity if coupled to at least two internal locations of a given unit cell, and a given link is defined as an inter-connectivity if coupled to an external location of at least two unit cells.

In another aspect of the first embodiment, one or more of the links independently comprise a magnetic element, electro-static element, piezo-electric element, pneumatic element, hydraulic element, magneto-rheological element, electro-rheological element, photonically-sensitive element, phononically-sensitive element, or thermally-sensitive element.

In another aspect of the first embodiment, the links are responsive to a duty cycle of ON and OFF states to provide a selectable dynamic level of elasticity of unit cells within the at least a subset of the unit cells or the at least a sub-array of the unit cells, wherein a period of the duty cycle has a frequency above a mechanical inertial bandwidth of the links to provide for a continuous range of intermediate states between the ON and OFF states.

In another aspect of the first embodiment, the apparatus further comprises an excitation conducting element arranged in association with the material of the unit cells and configured to enable a stimulus to cause a state change of at least one of the links. The excitation conducting element can be, for instance, an electron-conducting element, photon-conducting element, sound-wave conducting element, or heat-conducting element.

In another aspect of the first embodiment, the apparatus further comprises an excitation source to provide a stimulus to at least one of the links, a wireless receiver coupled to at least one of the links, or an excitation conducting element arranged in association with the material of the unit cells and configured to enable a state change of at least one of the links. The excitation source can include one or more of an electron-generator, photon-generator, sound-wave generator, heat source, or wireless-communications generator.

In another aspect of the first embodiment, the apparatus further comprises a controller that activates the excitation source, and wherein the excitation source and controller are mechanically coupled to the array or a structure to which the array is coupled and communicatively coupled to the at least a subset of the links; or the excitation source and controller are not mechanically coupled to the array or structure but are communicatively coupled to the at least a subset of the links.

In another aspect of the first embodiment, the controller is configured to control a switching array having switches operatively coupled to respective links, the switches effecting the ON and OFF states of the respective links; or the controller is configured to control a power source to provide power to the links via the switches as a function of the ON and OFF states of the respective links.

A second embodiment of the invention provides a method comprising stiffening and relaxing one or more links coupled to unit cells in an array of the unit cells to change elasticity of at least a subset of the unit cells or at least a sub-array of the unit cells, the unit cells formed from a material, each cell defining a shape, the stiffening and relaxing being a function of an ON state and an OFF state of the one or more links.

In an aspect of the second embodiment, the method further comprises controlling the one or more links by configuring a switching array to provide a stimulus to the one or more links.

In another aspect of the second embodiment, the method further comprises applying the stimulus, the stimulus being at least one of voltage, current, photonic signal, phononic signal, or heat.

In another aspect of the second embodiment, a given link is an intra-connectivity coupled to at least two locations within a corresponding unit cell of the at least a subset of the unit cells; or a given link is an inter-connectivity between or among unit cells within the at least a sub-array of the unit cells; and a given link is fixed or switchable; and a given link is defined as an intra-connectivity if coupled to at least two internal locations of a given unit cell, and a given link is defined as an inter-connectivity if coupled to an external location of at least two unit cells.

In another aspect of the second embodiment, the one or more links independently comprise a magnetic element, electro-static element, piezo-electric element, pneumatic element, hydraulic element, magneto-rheological element, electro-rheological element, photonically-sensitive element, phononically-sensitive element, or thermally-sensitive element.

In another aspect of the second embodiment, the ON state and OFF state of the one or more links is controlled by an excitation conducting element arranged in association with the material of the unit cells and configured to enable a state change of the one or more links, the excitation conducting element being an electron-conducting element, photon-conducting element, sound-wave conducting element, or heat-conducting element.

In another aspect of the second embodiment, the method further comprises applying a duty cycle of ON and OFF states to the one or more links, the one or more links being responsive to the duty cycle to provide a selectable dynamic level of elasticity of the at least a subset of the unit cells or the at least a sub-array of the unit cells, wherein a period of the duty cycle has a frequency above a mechanical inertial bandwidth of the one or more links to provide for a continuous range of intermediate states between the ON and OFF states.

A third embodiment of the invention provides an apparatus comprising means for deforming one or more unit cells within an array or an arrangement of the one or more unit cells within the array; and means for enabling or causing the deforming.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of example programmable lattice materials in which activation patterns, specimen deformations, and periodic deformations are depicted.

FIGS. 2A-2C are diagrams that illustrate 3D printed programmable lattice materials.

FIG. 3A is a schematic diagram of an example apparatus having an excitation source, controller, switching array, unit cells, receiver and excitation conducting element.

FIGS. 3B-3F are plots of a pulse width modulation signal with a selectable duty cycle produced by an excitation source to drive a switchable link.

FIGS. 4A-4G are diagrams of lattice materials and structures having programmable linear elastic properties and corresponding plots of their mechanical responses for three different programmed performance paths.

FIGS. 5A-5C are diagrams and performance plots of embodiments of switchable unit cells.

FIGS. 6A-6C are diagrams of lattice materials with programmable nonlinear elastic responses and a corresponding plot of an effective stress-strain response.

FIGS. 7A and 7B are diagrams of a square lattice structure with programmable elastic response subjected to uniaxial loading.

FIGS. 8A-8F are diagrams of a structure with programmable Poisson's ratio.

FIGS. 9A-9D are schematic diagrams of the unit cell with collinear locking mechanism showing the three activation modes of ON, OFF and Constant Force (CF).

### DETAILED DESCRIPTION OF THE INVENTION

Embodiments of the present invention enable reversible, real-time and tunable control of elastic moduli of a material that can be applied to a number of technologies. Some applications include morphing metamaterials, expandable biomedical devices, micro electro mechanical systems (MEMS), soft robotics, vibration isolators and acoustic metamaterials. The potential for modification of elastic modulus has been previously reported for some homogenous solid materials, such as metallic oxides (see Wachtman Jr, J., et al., Exponential temperature dependence of Young's modulus for several oxides. Physical Review, 1961. 122(6): p. 1754), polymers (see Li, R. and J. Jiao, The effects of temperature and aging on Young's moduli of polymeric based flexible substrates, in PROCEEDINGS-SPIE THE INTERNATIONAL SOCIETY FOR OPTICAL ENGINEERING, 2000. International Society for Optical Engineering; 1999, and Gandhi, F. and S.-G. Kang, Beams with controllable flexural stiffness, in The 14th International Symposium on: Smart Structures and Materials & Nondestructive Evaluation and Health Monitoring, 2007, International Society for Optics and Photonics), ultra-high temperature ceramics (see Li, W., et al., A model of temperature-dependent Young's modulus for ultrahigh temperature ceramics, Physics Research International, 2011) and shape memory alloy or polymer structures (see Rossiter, J., et al., Shape memory polymer hexachiral auxetic structures with tunable stiffness, Smart Materials and Structures, 2014. 23(4): p. 045007; Hassan, M. R., et al., Smart shape memory alloy chiral honeycomb. Materials Science and Engineering: A, 2008, 481: p. 654-657; and McKnight, G., et al., Segmented reinforcement variable stiffness materials for reconfigurable surfaces, Journal of Intelligent Material Systems and Structures, 2010. 21(17): p. 1783-1793) subjected to a varying temperature field. However, the maximum amount of increase in elastic modulus in these materials is generally less than an order of magnitude.

More complex material systems providing a wider range of tunability include magnetic particle loaded elastomers under an external magnetic field (see Varga, Z., G. Filipcsei, and M. Zrinyi, Magnetic field sensitive functional elastomers with tuneable elastic modulus, Polymer, 2006, 47(1): p. 227-233; Abramchuk, S., et al., Novel highly elastic magnetic materials for dampers and seals: part II. Material behavior in a magnetic field, Polymers for Advanced Technologies, 2007, 18(7): p. 513-518; and Shiga, T., A. Okada, and T. Kurauchi, Magnetroviscoelastic behavior of composite gels, Journal of Applied Polymer Science, 1995. 58(4): p. 787-792), particle jamming mechanisms activated by vacuum pressure (see Brown, E., et al., Universal robotic gripper based on the jamming of granular material, Proceedings of the National Academy of Sciences, 2010. 107(44): p. 18809-18814; and Trappe, V., et al., Jamming phase diagram for attractive particles, Nature, 2001. 411(6839): p. 772-775), fluidic flexible matrix composites under hydraulic pressure (see Shan, Y., et al., Variable stiffness structures utilizing fluidic flexible matrix composites, Journal of Intelligent Material Systems and Structures, 2009, 20(4): p. 443-456.), beams with electrostatically tunable bending stiffness (see Bergamini, A., et al., A sandwich beam with electrostatically tunable bending stiffness, Smart materials and structures, 2006. 15(3): p. 678; and Henke, M., J. Sorber, and G. Gerlach, Multi-layer beam with variable stiffness based on electroactive polymers, in SPIE Smart Structures and Materials+Nondestructive Evaluation and Health Monitoring, 2012, International Society for Optics and Photonics), soft-matter composites embedded with channels of magnetorheological fluid and activated by magnetic field (see Majidi, C. and R. J. Wood, Tunable elastic stiffness with microconfined magnetorheological domains at low magnetic field, Applied Physics Letters, 2010, 97(16): p. 164104) and elastomers embedded with a low-melting-point metal and a soft-matter resistance heater (see Shan, W., T. Lu, and C. Majidi, Soft-matter composites with electrically tunable elastic rigidity, Smart Materials and Structures, 2013. 22(8): p. 085005). In spite of these advances in achieving tunable elasticity, the need for varying ambient temperature or magnetic fields as external stimuli, or the need for hydraulic/pneumatic actuation using pumps, valves and fluid channels in these materials lessens the interest and feasibility of employing these structures as real-time tunable elasticity options for versatile design and application.

An embodiment of the present invention provides an elegant solution for controlling linear and non-linear elastic properties of certain materials by several orders of magnitude using for example, electrically switched electromagnetic engagement at certain locations within a material's framework. The control of linear elastic properties may be obtained through the real-time adjustment of strut connectivity of lattice materials, displaying a wide range of moduli between a fully bending-dominated incompressible network and one that is controlled by stretching of unit-cell walls. The adjustment over nonlinear elastic (i.e., post-buckling) behavior in a lattice material is achieved by altering a natural deformation mode of the lattice and forcing it to buckle in a pre-selected mode with higher strain energy through switchable electromagnetic interactions.

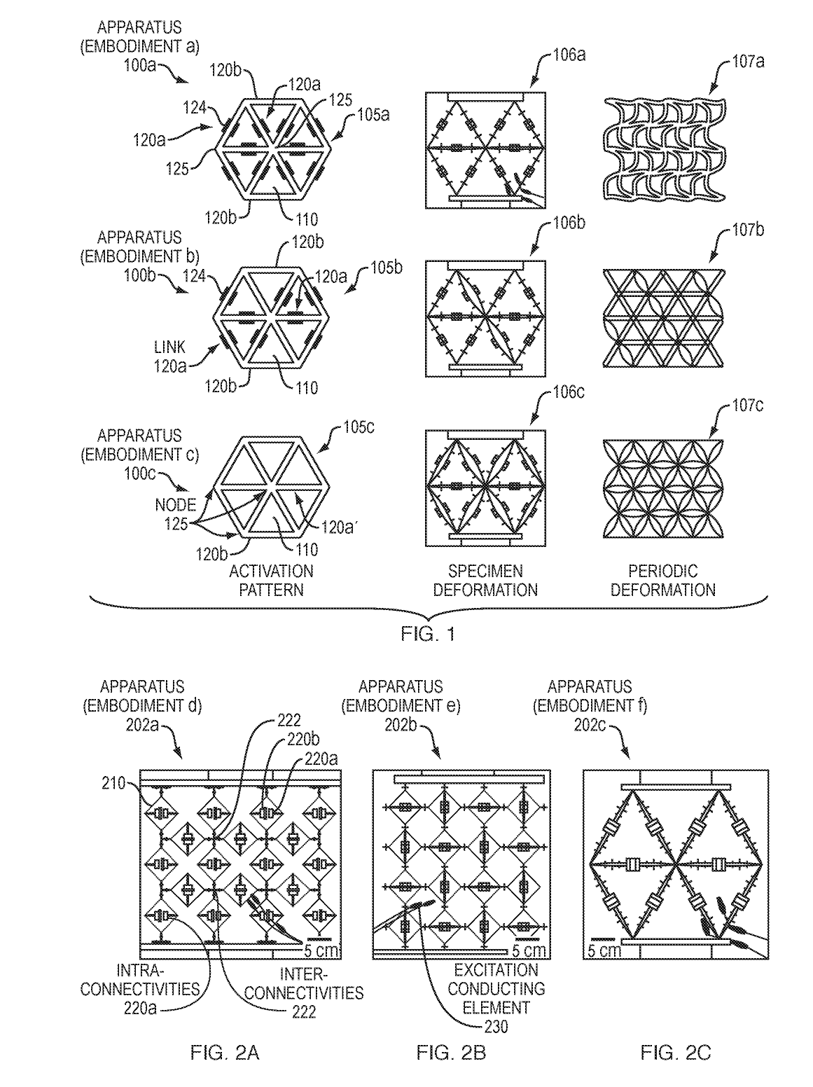

As illustrated in FIG. 1, some embodiments of the present invention provide an apparatus (100a-c) comprising an array of one or more unit cells (110), formed from a material, each unit cell (110) defining a shape. In the embodiment of FIG. 1, there is one unit cell 110. The unit cell includes links (120a, 120b) coupled to the unit cells (110) at nodes (125). At least a subset of the links (120a) enable changing of an elasticity of the unit cell (110) as a function of a state of the at least a subset of the links (120a), the state including ON and OFF states. The links may be fixed links (120b) or switchable links (120a). Elements (124), such as electromagnets, having at least two discrete states or analog adjustment capability are employed to enable adjustments of the switchable links (120a).

In an embodiment (100a), the apparatus has an activation pattern (105a) that is a function of the fixed links (120b) and switchable links (120a). The activation pattern (105a) results in a specimen deformation (106) and periodic deformation pattern (107a). In another embodiment (100b), the apparatus has an activation pattern (105b), resulting in a specimen deformation (106b) and periodic deformation (107b). In another embodiment (100c), the apparatus has an activation pattern (105c), resulting in a specimen deformation (106c) and periodic deformation (107c).

FIGS. 2A-2C illustrate example 3D printed programmable lattice materials arranged in array (202a-c) of unit cells (210) with real-time control of orthotropic Young's modulus, orthotropic Poisson's ratio, and buckling strength.

The embodiment (200a) illustrated in FIG. 2A comprises an array 202a of switchable unit cells (210) that are positioned in the middle of sides of an underlying square grid in alternating vertical and horizontal orientations. The unit cells (210) forming the array (202a) contain switchable intra-connectivity links (220a). Switchable intra-connectivity links (220a) are coupled to at least two locations within a corresponding unit cell (210) and, according to some embodiments, enable the unit cell (210) to function as a spring with a switchable spring constant. According to some embodiments, the switchable intra-connectivity links (220a) inside the unit cells (210) contain electromagnets connected to an excitation conducting element (230), such as electrical wires, that carries a stimulus, such as electrical current, to control the state of the unit cell (210) by activating or deactivating the switchable links (e.g., the electromagnets inside the switchable link).

The unit cells (210) are connected to each other by fixed inter-connectivity links (222). Inter-connectivity links are located between or among unit cells (210), thereby forming an array or sub-array of unit cells, and are each coupled to an external location of at least two unit cells. Both intra-connectivity links and inter-connectivity links may be fixed or switchable. It should be noted that the array (202c) of FIG. 2C is an array of one unit cell.

In an example implementation, the apparatuses illustrated in FIGS. 2A-2C may be constructed with 3D printed rigid opaque photopolymers having a Young's modulus of 2 GPa and a tensile strength of 55 MPa, and example electromagnets inside the intra-connectivity links (220) provide a holding force of 5.5 lbs. and a response time of about 4 milliseconds.

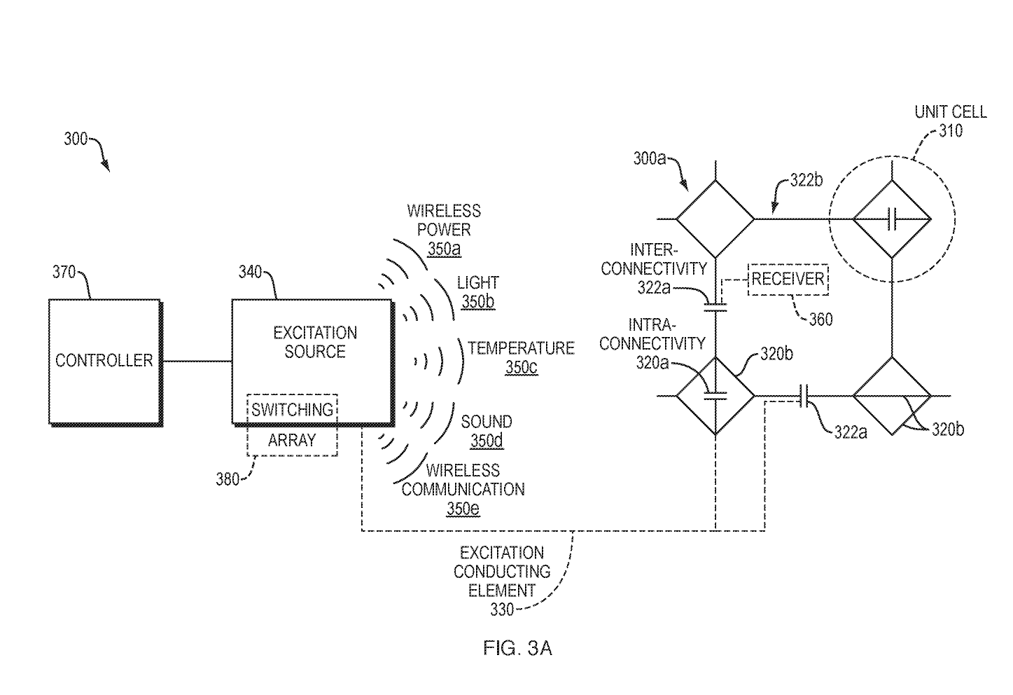

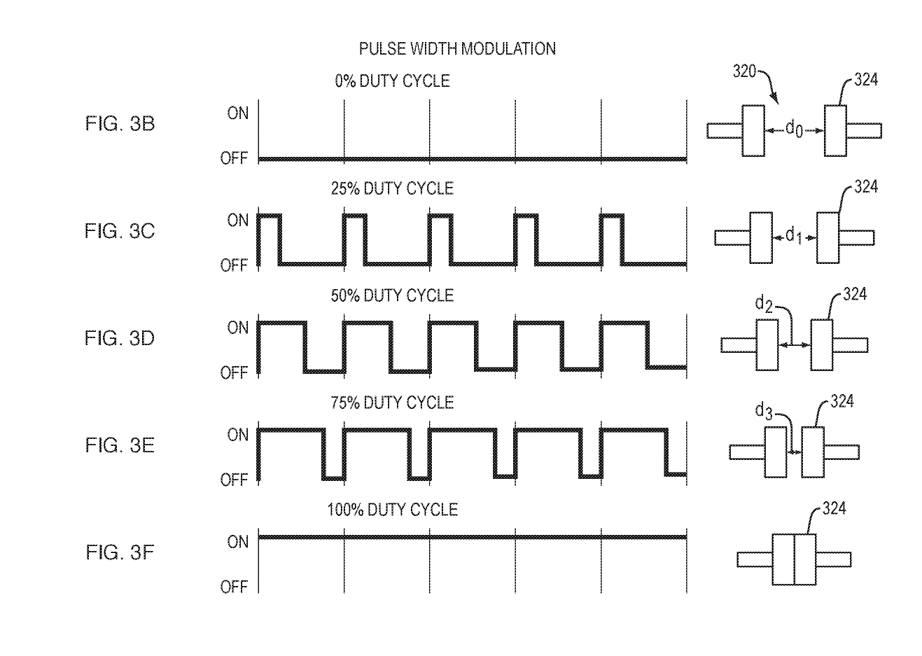

FIG. 3 shows an embodiment (300) that includes an excitation source (340) configured to provide a stimulus capable of operating at least one of the switchable links (320a, 322a) in the array (300a). The switchable links (320a, 322a) can comprise various types of elements capable of switching between at least two different states. For example, the switchable links (320a, 322a) may include a magnetic element, electro-static element, piezo-electric element, pneumatic element, hydraulic element, magneto-rheological element, electro-rheological element, photonically-sensitive element, phononically-sensitive element, and/or thermally-sensitive element.

According to some embodiments, the switchable links (320a, 322a) are responsive to a duty cycle of ON and OFF states to provide a selectable dynamic level of elasticity of the switchable links (320a, 322a) within the array (300a) unit cells (310). In some embodiments, a controller 370 signals the excitation source 340 to drive the switchable links (320a, 322a) with an amplitude and frequency having the duty cycle to be above a mechanical inertial bandwidth of the switchable links (320a, 322a) to provide for a continuous range of intermediate states between the ON and OFF states. In another embodiment, the controller 370 causes the excitation source 340 to drive the switchable links (320a, 322a ) with a pulse width modulation having a duty cycle of ON and OFF states.

FIGS. 3B-3F illustrates a pulse width modulation signal with a selectable duty cycle used to drive a switchable link (320), according to some embodiments. FIG. 3B shows a pulse width modulation signal with a 0% duty cycle, resulting in the switchable link (320) being in a fully OFF state. In this embodiment, the switchable link (320) includes two electromagnets (324) that when in a fully OFF state, are at a level of maximum elasticity and/or separated by a distance d₀.

In FIG. 3C, the controller 370 signals the excitation source 340 to increase the duty cycle of the pulse width modulation to 25%. This results in the level of the elasticity of the switchable link (320) to decrease and/or the distance between the two electromagnets (324) to decrease from d₀ to d₁. In this embodiment, the switchable link (320) may not fully close, because the amplitude and the frequency of the pulse width modulation signal are above the mechanical inertial bandwidth of the switchable link (320). Thus, varying the duty cycle of the pulse width modulation signal can provide a switchable link (320) with a continuous range of intermediate states between ON and OFF.

For example, in FIG. 3D the duty cycle of the pulse width modulation signal is increased to 50%. This causes the level of the elasticity of the switchable link (320) to further decrease and the distance between the two electromagnets (324) to again decrease from d₁ to d₂. FIG. 3E illustrates another selectable level of elasticity, where the duty cycle of the pulse width modulation is increased to 75%. This causes the level of the elasticity of the switchable link (320) to further decrease and the distance between the two electromagnets (324) to again decrease from d₂ to d₃. FIG. 3F shows a 100% duty cycle, resulting in the switchable link (320) being in a fully ON state, resulting in a closed switchable link (320) with the electromagnets contacting each other.

Referring back to FIG. 3A, the array (300a) includes unit cells (310) having a defined two- or three-dimensional geometrical shape. The defined shapes of the unit cells (310) in the array may include any combination of the following example shapes: a circle, sphere, oval, ellipse, ellipsoid, triangle, kagome, tetrahedron, pyramid, cone, square, cube, rectangle, cuboid, cylinder, rhombus, trapezoid, pentagon, hexagon, heptagon, octagon, octahedron, dodecahedron, or octet. Further, the unit cells (310) may include various materials, including: polymers, plastics, ceramics, metals, metal oxides, metal alloys, cellular materials, foams, carbon fiber, biomaterials, or composites thereof.

According to some embodiments, the unit cells (310) are connected together with fixed interconnectivity links (322b) and/or switchable interconnectivity links (322a). At least one of the unit cells (310) forming the array (300) contains a switchable intra-connectivity link (322a) or fixed intra-connectivity link (320b). Intra-connectivity links (320a, 320b) are coupled to at least two locations within a corresponding unit cell (310). In some embodiments, switchable intra-connectivity links (320a) enable the unit cell (310) to stiffen or relax based on the respective state. In other embodiments, the switchable intra-connectivity links (320a) enable the unit cell (310) to function as a spring with a switchable spring constant.

According to some embodiments, the excitation source (340) can be configured to operate the switchable links (320a, 322a) by providing a stimulus through a physical excitation conducting element (330) arranged in association with the unit cells (310) and/or switchable links (320a, 322a). The stimulus is capable of causing a state change of at least one of the switchable links (320a, 322a). For example, the excitation source (340) may be one or more of an electron-generator, photon-generator, sound-wave generator, or heat source. Depending on the chosen excitation source (340), the excitation conducting element may include an electron-conducting element, photon-conducting element, sound-wave conducting element, or heat-conducting element.

According to other embodiments, the excitation source (340) may operate the switchable links (320a, 322a) wirelessly by communicating with a receiver (360) capable of switching the state of the switchable links (320a) operatively connected to the receiver (360). The excitation source (340) may be configured to provide various types of wireless stimuli, such as wireless communication signals (350e), capable of communicating with the receiver to operate the switchable links (320a, 322a). The wireless communication signals 350e may be an electromagnetic spectrum signal, such as radio frequency, for example, Bluetooth®, or optical wavelength. In other embodiments, the wireless stimulus may operate on directly on the switchable links (320a, 322a) to drive the state change without the need for a receiver. Examples of wireless stimuli include wireless power (350a), light (350b), temperature (350c), or sound (350d), or any combination thereof.

According to some embodiments, the controller (370) may be configured to activate and control the excitation source (340). In other embodiments, the controller (370) may also or alternatively be configured to control a switching array (380) having switches effecting the ON and OFF states of the operatively coupled switchable links (320a, 322a). The switching array (380) may be an internal component of the excitation source (340) or separate from the excitation source (380). In some embodiments, the switching array (380) may be configured to enable independent operation of any combination of a plurality switchable links (320a, 322a) in the array (300). In other embodiments, the controller (370) is configured to control a power source (340) to provide power to the switchable links (320a, 322a), via the switching array (380) and a power conducting element (330), as a function of the ON and OFF states of the respective switchable links (320a, 322a).

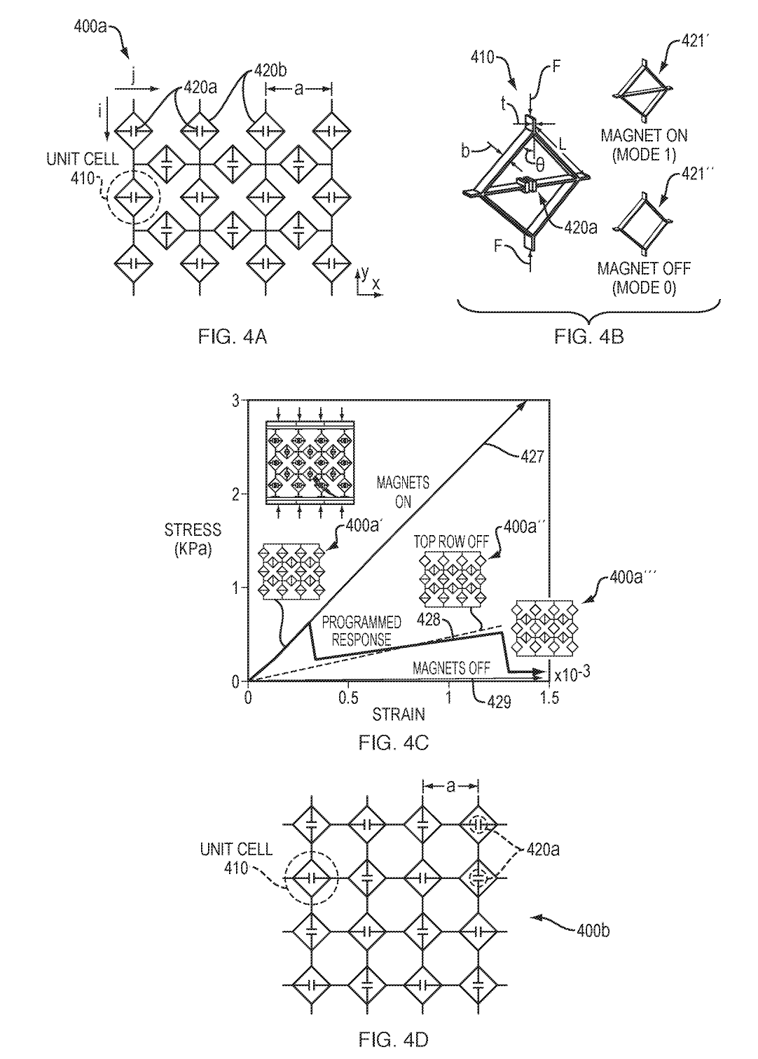

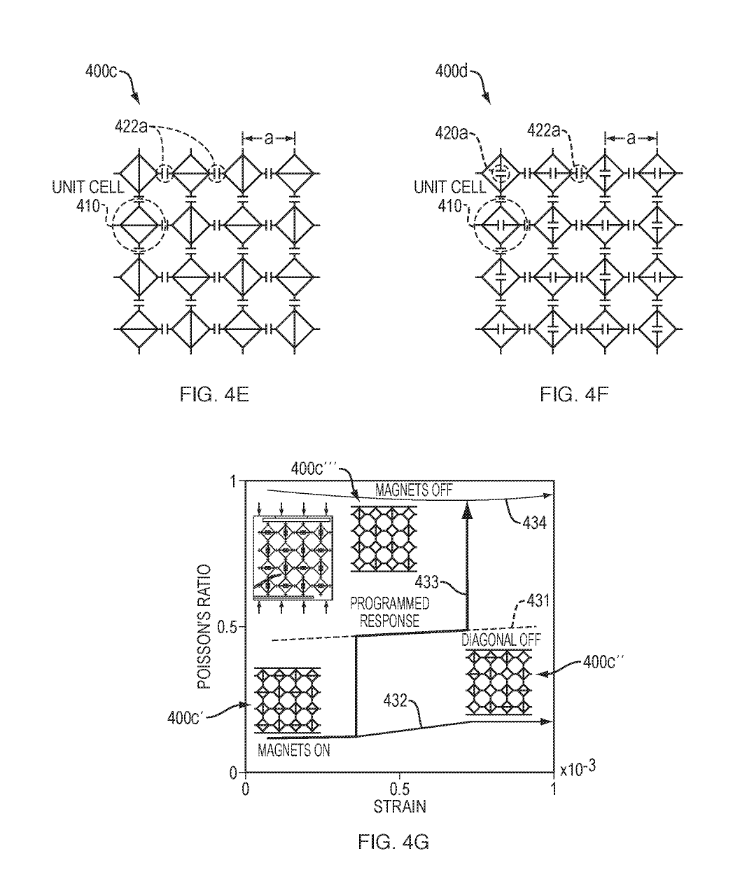

FIGS. 4A-4G illustrate lattice materials with programmable linear elastic properties. FIGS. 4A, 4D, 4E and 4F are schematic diagrams of arrays of square-based lattice unit cells, formed of materials, equipped with unit cells (410) having real-time switchable links (420a) for the control of orthotropic Young's modulus and Poisson's ratio.

In some embodiments, electrically conductive traces (not shown) may be used to carry electrons through the lattice materials to the switchable links (420a). For example, an LED or other stimulus generating element (not shown) may be locally associated with a switchable link (420a) to provide a stimulus (e.g., amplified electronic signal, photons, heat) to the switchable link (420a). Responsive to the stimulus, the corresponding switchable link (420a) performs its switching action. In such an embodiment, the traces are accessible via an external port (not shown) at external face of the lattice materials to enable an external driver (not shown), such as a power amplifier, power supply, or digital logic, to activate and deactivate the stimulus elements. Other external drivers, such as fluid pumps, may be employed in cases in which the stimulus generating element is a pneumatic driver and the conductive traces are, instead, fluid flow paths or tubes.

FIG. 4A is a schematic diagram of an embodiment (400a) of a cellular material with real-time tunable stiffness of an array of switchable stiffness units (410) (i.e., unit cells) that are positioned in the middle of sides of an underlying square grid in alternating vertical and horizontal orientations. The unit cells (410) function as springs with a switchable spring constant.

FIG. 4B is a schematic diagram of a unit cell (410) with programmable stiffness and lateral expansion. Each unit cell (410), shown in FIG. 4B in a ‘vertical’ orientation, includes four oblique beams and two transverse beams, which originate from the vertices, also referred to herein as nodes, of each pair of oblique beams and are connected through two electromagnets, forming a switchable link (420a) in the middle of the unit cell (410). According to this embodiment (400a), the unit cells (410) are arranged in a square-based grid that has a four-fold symmetry and, therefore, possesses transversely orthotropic material behavior.

In mode 0 of actuation (i.e., electromagnets deactivated) (421″), the Maxwell stability criterion requires the loaded unit cell (410) to be both statically and kinematically indeterminate and deform by cell edge bending when loaded according to M=2j−b−3=2×4−4−3=1>0, where b and j are the number of struts and frictionless joints in the unit cell (410), respectively, and M is the number of inextensional mechanisms of the unit cell (410) (see Maxwell, J. C., L. on the calculation of the equilibrium and stiffness of frames, The London, Edinburgh, and Dublin Philosophical Magazine and Journal of Science, 1864, 27(182): p. 294-299). In mode 1 of actuation (i.e., electromagnets activated) (421′), however, the unit cell (410) is a properly triangulated frame with stretch-dominated behavior, since M=2j−b−3=2×4−5−3=0, and is much stiffer because the transverse bar carries tension.

The effective orthotropic Young's modulus in compression of the lattice material (400a) in FIG. 4A can be calculated as

$${E}_{0} = \frac{{Et}^{3}}{{L}^{3} {sin}^{2} θ} and {E}_{1} = \frac{Et {cos}^{2} θ}{L ( 1 + 2 {sin}^{3} θ )}$$

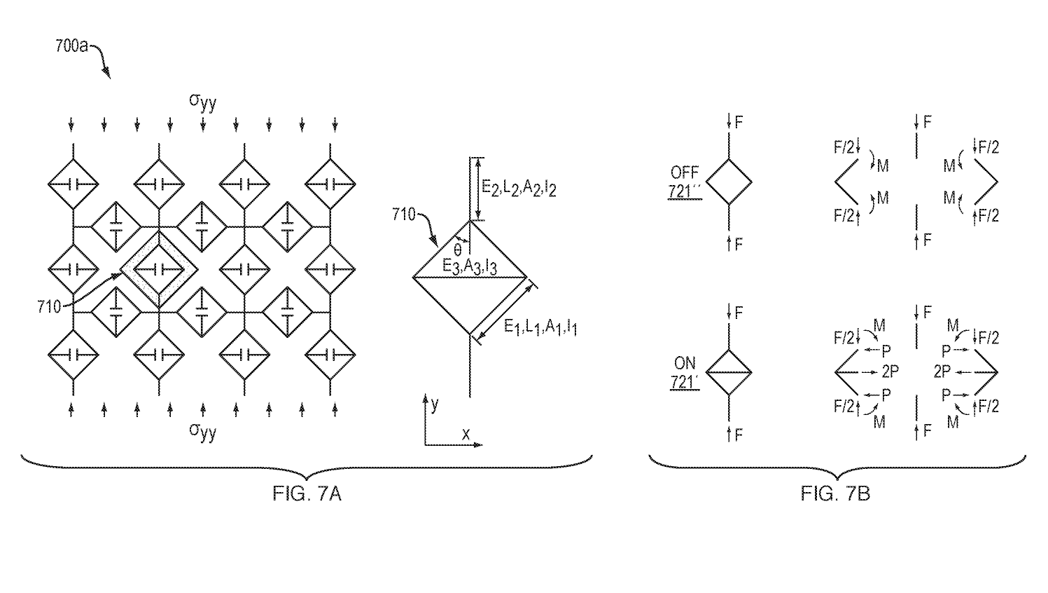

for the case where all the unit cells (410) are in modes 0 (421″) and 1 (421′) of actuation, respectively, where E is the elastic modulus of lattice cell wall material and θ, t and L are the angle from vertical line, thickness and length of the oblique beams (refer to FIGS. 7A and 7B and their respective descriptions below for a detailed derivation of the elastic moduli of the lattice material in the two actuation modes).

For the lattice material (400a) shown in FIG. 4A with t/L [symbol] 0.045 and θ=45°, the stiffness-to-softness modulus ratio is obtained theoretically as E₁/E₀=72, which is in reasonable agreement with the ratio of E₁/E₀=56 from experimental data.

Although the uniform actuation of switchable stiffness unit-cell (410) results in discrete values of effective stiffness, the selective actuation of electromagnets (420a ) in the lattice material can be used to obtain a nearly continuous range of effective elastic moduli. To estimate the stiffness under vertical compression, the pattern of activation for the vertical switchable stiffness units (410) in the square-based structure (400a) shown in FIG. 4A is assumed to be periodic and according to the Cartesian tiling of the m-by-n matrix C, called the representative volume element (RVE) of the structure. As a result, the stiffness of the structures is approximated by the effective stiffness of the RVE. Given that the binary value of actuation for a unit located in column i and row j of the RVE is represented by Cᵢⱼ, the effective stiffness of the RVE, denoted by E_{y}^{eff}, can be estimated as

$${\sum }_{j = 1}^{n} {( {\sum }_{i = 1}^{m} {( \frac{m ( {E}_{0} + {C}_{ij} ( {E}_{1} - {E}_{0} ) )}{n} )}^{- 1} )}^{- 1} \leq {E}_{y}^{eff} \leq {( {\sum }_{i = 1}^{m} {( {\sum }_{j = 1}^{n} \frac{m ( {E}_{0} + {C}_{ij} ( {E}_{1} - {E}_{0} ) )}{n} )}^{- 1} )}^{- 1} \qquad ( 1 )$$

where the lower- and upper-bounds in this relationship are obtained assuming the strain field as uniform in x- and y-directions, respectively. The effective compressive orthotropic Young's modulus of the structure in the general case falls between the two extremes of the purely bending-dominated modulus, E_{0 (i.e. C}ᵢⱼ=0; 1≤i≤m, 1≤j≤n), and the purely stretching-based modulus, E₁ (i.e. Cᵢⱼ=1; 1≤i≤m, 1≤j≤n). The effective stiffness in stretching- and bending-dominated periodic 2D structures are proportional to the relative density of the structure and its cube, respectively (see Gibson, L. J. and M. F. Ashby, Cellular solids: structure and properties. 1999: Cambridge Univ Pr.). As a result, the value of Young's modulus, given in (1), can be instantaneously changed over 2to 4 orders of magnitude in low density cellular materials (i.e., t/L<<1).

FIGS. 4C and 4G show corresponding plots of mechanical response for three different programmed paths. Red (diagonal) and blue (substantially horizontal) lines, 427 and 429, respectively, show the cases where all the electromagnets (420a) are ON (420) and OFF (420′), respectively.

The actual stress-strain (“programmed”) response 428 of an embodiment (400a) structure under displacement-controlled vertical compression is shown in FIG. 4C. The loading was applied using an Instron tester at a strain rate of 5*10⁻⁵ s⁻¹. The structure's (400a) response when all the electromagnets (420a) are deactivated (421″) or activated (421′) and also a programmed response 428 are plotted in FIG. 4C. In the programmed response, a purely stretching-dominated deformation mode (i.e., all electromagnets activated) (400a′) is followed until ε=3*10⁻⁴. At this compression level, all three vertical switchable stiffness units in the first row are deactivated (400a″), resulting in the separation of the electromagnets (420a) and a sudden a drop in load. The dashed line in FIG. 4C corresponds to the lattice material where the electromagnets (420a) on the top row of the lattice were deactivated (400a″). An intermediate path is then followed until ε=1.3*10⁻³, where the electromagnets are entirely deactivated (400a″). A bending-dominated, soft response follows afterwards.

Active control over the Poisson's ratio is achieved using a tessellation of unit cells (410) as shown in FIG. 4D. In this embodiment (400b), each switchable elasticity unit (i.e., unit cell) (410), is located at the nodes of an underlying square grid. The unit cells (410) alternate from a vertical to a horizontal orientation in rows and columns within the periodic lattice to give the structure a geometrical four-fold symmetry and an equal response in the x and y directions.

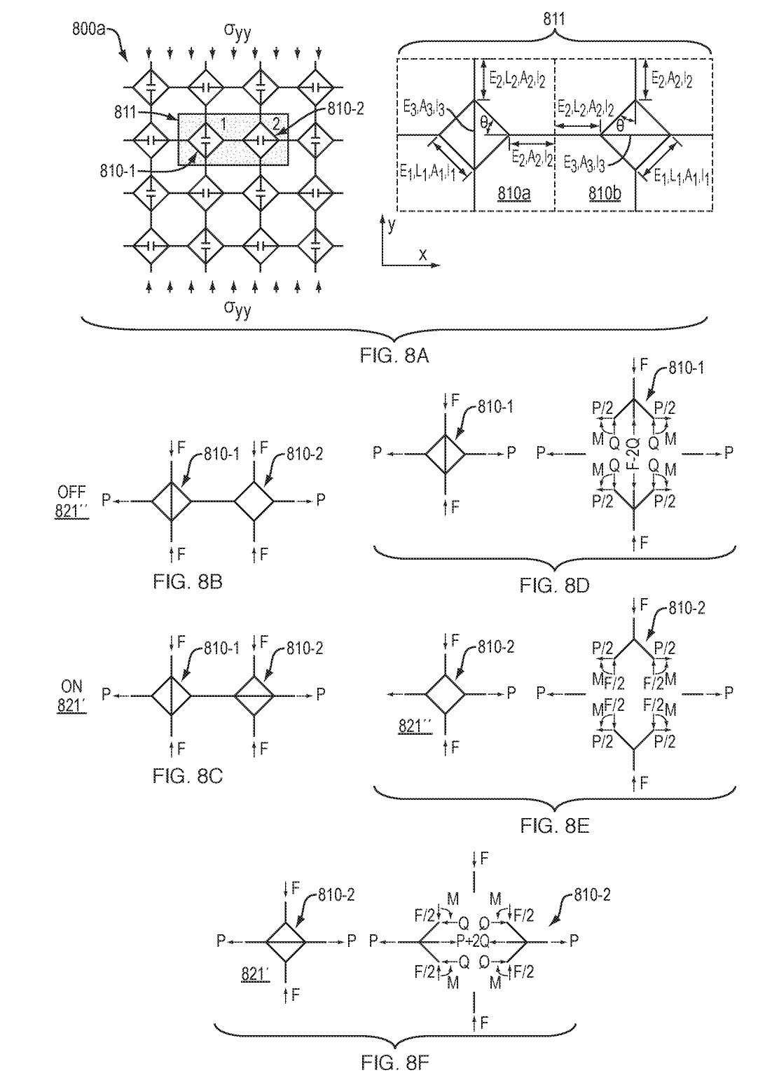

When all the switchable links (420a), e.g., electromagnets, are deactivated (421″), the vertical and horizontal units show a bending- and stretching-dominated response under y-loading, respectively, and, for a lattice with θ=45°, the amount of lateral expansion in the lattice material is almost equal to the axial contraction. When all the switchable links (420a) are activated (421′), the lattice material is entirely stretching-dominated with smaller lateral expansion. For θ=45°, the effective Poisson's ratio for the periodic structure, v_{yx}, can be expressed as −1 (i.e., nearly incompressible) and \sqrt{2}/(1+(α/L)) in modes 0 (421″) and 1 (421′) of actuation, respectively (FIGS. 8A-8F and their respective descriptions below for analytical derivation of the Poisson's ratio in the two deformation modes).

A value of effective incremental Poisson's ratio from experimentation is plotted versus the axial compression for various patterns of actuation in FIG. 4G. In FIG. 4G, the programmed response 433 (illustrated as a green line) of the lattice under axial compression starts with all the electromagnets (420a) in the activated mode (400c′), resulting in small expansion in the transverse direction, as indicated by the lower curve 432. At a strain˜0.4*10⁻³, the electromagnets on the diagonal of the lattice are deactivated (400c″) and the material follows an intermediate response (illustrated as a dashed line 431). This is followed by a transition to a nearly incompressible response, when all the magnets are deactivated (400c′″) at a strain ˜0.7*10⁻³, as indicated by the upper curve 434.

FIGS. 4E and 4F illustrate embodiments (400c and 400d, respectively) each comprising an array of unit cells (410) that alternate from a vertical to a horizontal orientation in rows and columns within a periodic lattice. The embodiment (400c) shown in 4E illustrates switchable inter-connectivity links (420b) located between or among fixed unit cells (410) forming an array. According to this embodiment, the intra-connectivity links (420a) located within the unit cells (410) are fixed. Each of the switchable inter-connectivity links (422a) are coupled to an external location of at least two unit cells (410). The switchable inter-connectivity links (422a) are capable of operating similarly to the switchable intra-connectivity links (420a). For example, the switchable inter-connectivity links (422a) may include two electromagnets operably connected to an excitation source (340, shown in FIG. 3) capable of switching the switchable inter-connectivity links (422a) between at least an ON and OFF state.

The embodiment (400d) illustrated in FIG. 4F utilizes switchable inter-connectivity links (422a) to couple the unit cells (410) together and switchable intra-connectivity links (420a) within each of the unit cells (410). The embodiments shown in FIGS. 4A, 4D, 4E, and 4F are examples of possible arrangements and structures of unit cells (410) utilizing different combinations of switchable and fixed intra- and inter-connectivity links. One of ordinary skill in the art would recognize there is exists many other possible arrangements and structures of the embodiments of the present invention.

There are a few technical limitations associated with the embodiments shown in FIGS. 4A and 4D. First, the ability to control stiffness does not hold under macroscopic tensile stresses in these embodiments. In a periodic structure under tensile loading along x or y, the electromagnets in the unit cells (410) that are oriented perpendicular to the loading direction are compressed against each other and a stretch dominated response ensues. Second, the stiff-mode strength of the material under compression is limited to the tensile holding force of the electromagnets oriented perpendicular to the loading direction. Third, programmable softening would always be associated with a drop in load during displacement control experiments (or a sudden increase in displacement in load control experiments). This dynamic effect could lead to a destabilization in the system's response. Fourth, it is not possible to increase the effective stiffness at nonzero strains: once a soft response (electromagnets off) (421″) is selected at a unit cell (410) under loading, the magnet faces separate, and the unit cell (410) loses its ability to follow a stiff response until the structure is fully unloaded and the magnets become close enough to attract each other.

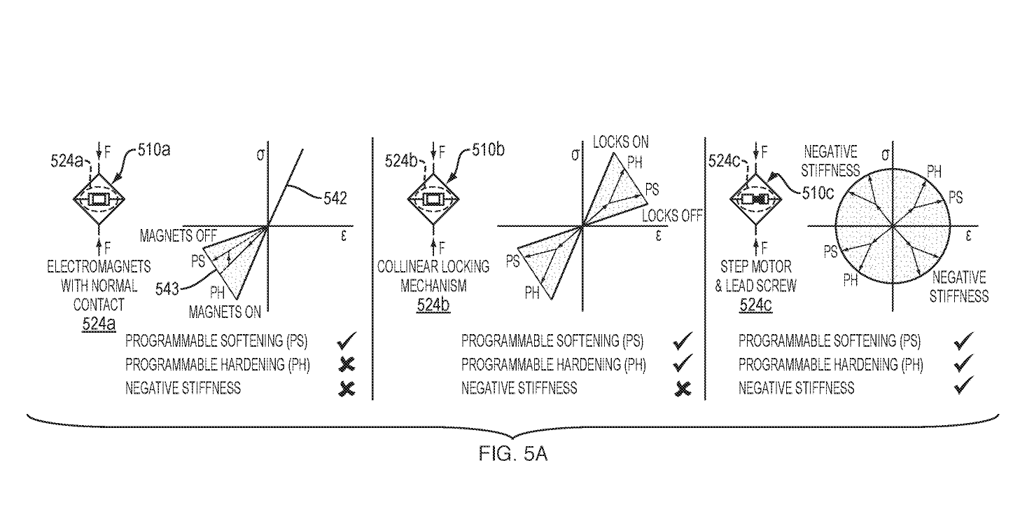

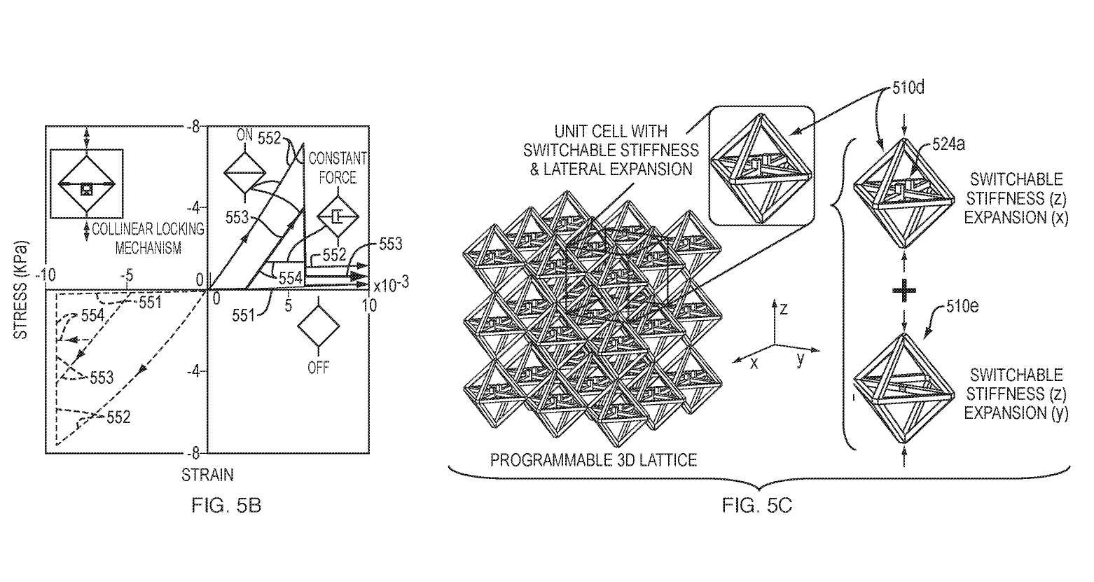

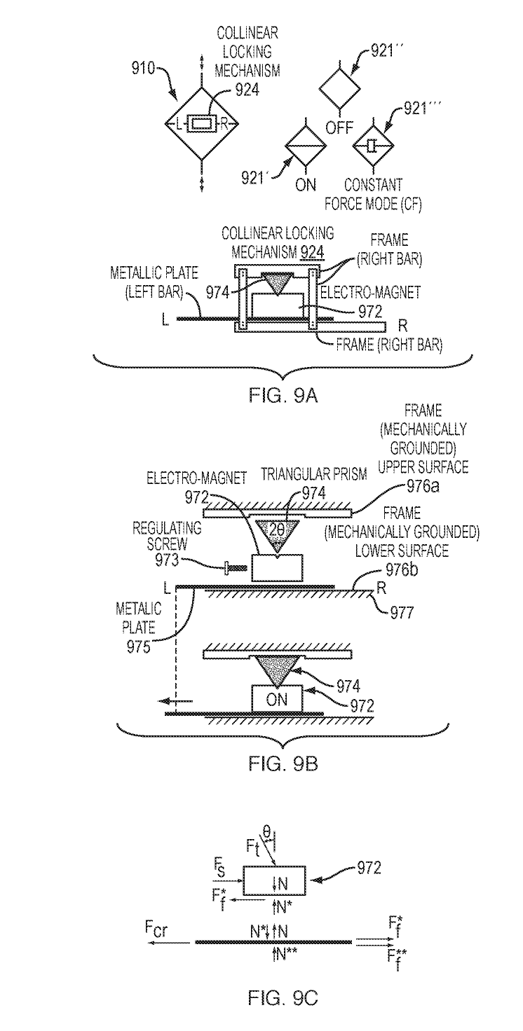

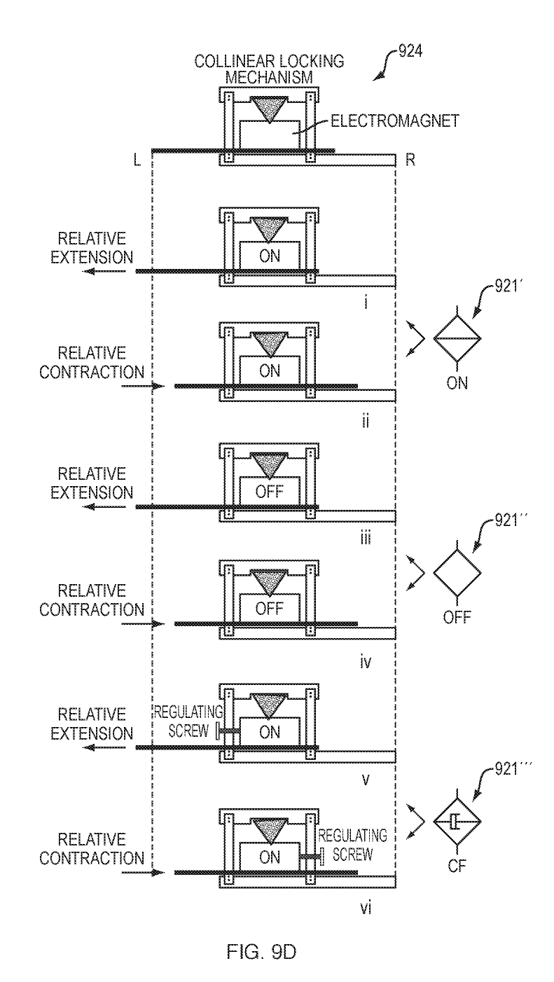

A chart given in FIG. 5A summarizes characteristics and functionalities of a previously introduced unit cell (510a) for the disclosed programmable elastic metamaterials. FIG. 5A also illustrates two additional embodiments (510b and 510c) for the switchable unit cell, which can effectively resolve the shortcomings mentioned above, while also providing a wider range of programmability and expanding the material workspace compared to the previously described unit cell (510a). In the unit cell (510b), shown in the middle of FIG. 5A, the pair of electromagnets (524a) in the original unit cell (510a) are replaced with a lockable sliding mechanism (524b), which allows a free, continuous, relative contraction or extension of two transverse beam segments in mode 0 and prevents this relative motion in mode 1 of actuation. Additionally, the locking mechanism (524b) can allow a relative extension or contraction of the two transverse beam segments at a constant force value (refer to FIGS. 9A-9D and their respective descriptions below for details on the collinear locking mechanism). This unit cell embodiment (510b) allows the periodic lattice material to be programmed to follow a new series of programmable paths that were not possible before, including programmed softening without stress drop, programmed hardening at non-zero strains, and dissipative hysteresis loop.

FIG. 5A also graphs the achievable paths (solid lines) 542 in the axial stress-strain work space (shaded area) 543 for each unit cell embodiment (510a, 510b, and 510c).

FIG. 5B is a graph of programmed responses for a programmable cellular material using the collinear locking mechanism (524b). The soft and hard responses are shown by blue and red lines (551 and 552), respectively. The green line (553) shows a programmed response achieved by a bending-dominated response starting at zero strain and a hardening at a nonzero strain ˜2.5*10⁻³ through a transition into a stretch dominated response. The purple line (554) shows a similar programmed response with a gradual hardening at strain˜2.5*10⁻³ and a gradual softening without stress drop at strain ˜3.9*10⁻³ through a transition from stretch-dominated response into constant-force mode. The dashed lines show similar responses in the compression region. The range of achievable stress-strain paths in this design is limited to all non-work-producing paths in the material workspace described by Eq. (1).

The unit cell embodiment (510c), shown on the far right of FIG. 5A, includes a stepper motor and a lead screw (524c) at the center of the unit cell (510c) connecting the two vertical beam segments. A lattice material that includes these unit cells (510c) is able to autonomously alter its shape as well as its material properties through relative extension or contraction of the two beam segments. Moreover, such material is able to traverse work-producing paths in its stress-strain space through the mechanical input of the stepper motor (520c). This capability further expands the material workspace into the negative stiffness zone. Negative stiffness values, having been shown to enable extreme mechanical damping (see Lakes, R., Extreme damping in compliant composites with a negative-stiffness phase. Philosophical magazine letters, 2001, 81(2): p. 95-100; Lakes, R. S., et al., Extreme damping in composite materials with negative-stiffness inclusions, Nature, 2001. 410(6828): p. 565-567; and Yap, H. W., R. S. Lakes, and R. W. Carpick, Negative stiffness and enhanced damping of individual multiwalled carbon nanotubes, Physical Review B, 2008. 77(4): p. 045423) or macroscopic stiffness in composites (see Lakes, R. S. and W. J. Drugan, Dramatically stiffer elastic composite materials due to a negative stiffness phase? Journal of the Mechanics and Physics of Solids, 2002. 50(5): p. 979-1009), are previously demonstrated in a limited number of materials and structural systems (see Dixon, M. C., et al., Negative stiffness honeycombs for recoverable shock isolation, Rapid Prototyping Journal, 2015. 21(2): p. 193-200; Estrin, Y., et al., Negative stiffness of a layer with topologically interlocked elements. Scripta Materialia, 2004. 50(2): p. 291-294; and Thompson, J. M. T., Paradoxical' mechanics under fluid flow, Nature, 1982. 296(5853): p. 135-137) that, unlike embodiments of the present invention, are intrinsically unstable (due to the absence of positive definiteness of energy) and, furthermore, they often rely on external constraints.

FIG. 5C shows a 3D elastic lattice material with programmable Young's modulus and Poisson's ratio based on the use of switchable unit cells. The lattice is obtained from cubic tessellation of octahedron shaped unit cells with switchable stiffness and lateral expansion (510d). The unit cells (510d) are arranged in alternating directions to give the 3D material a macroscopic cubic response along x, y and z axes. The unit cells (510d) are octahedron shaped units, where two orthogonal pairs of beams are extended along two of the three body diagonals of the octahedron, and each pair of beams are connected through electromagnets at the center of the unit. Each unit cell (510d) has switchable stiffness along the diagonal direction that has no beams and, when pressed along that direction, switchable lateral expansion along the other two diagonal directions. The unit cells (510d) are arranged in alternating orientations along the three principal directions of the lattice to give the 3D material a macroscopic cubic response.

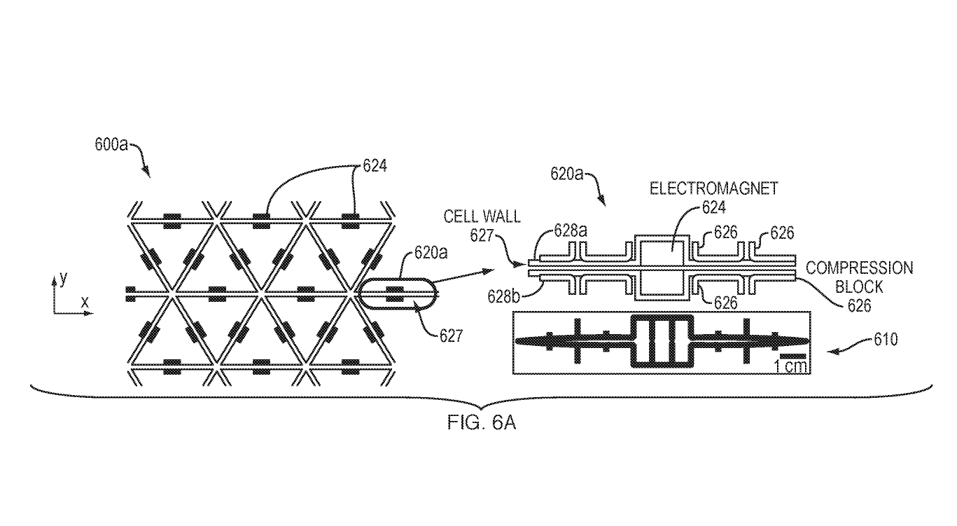

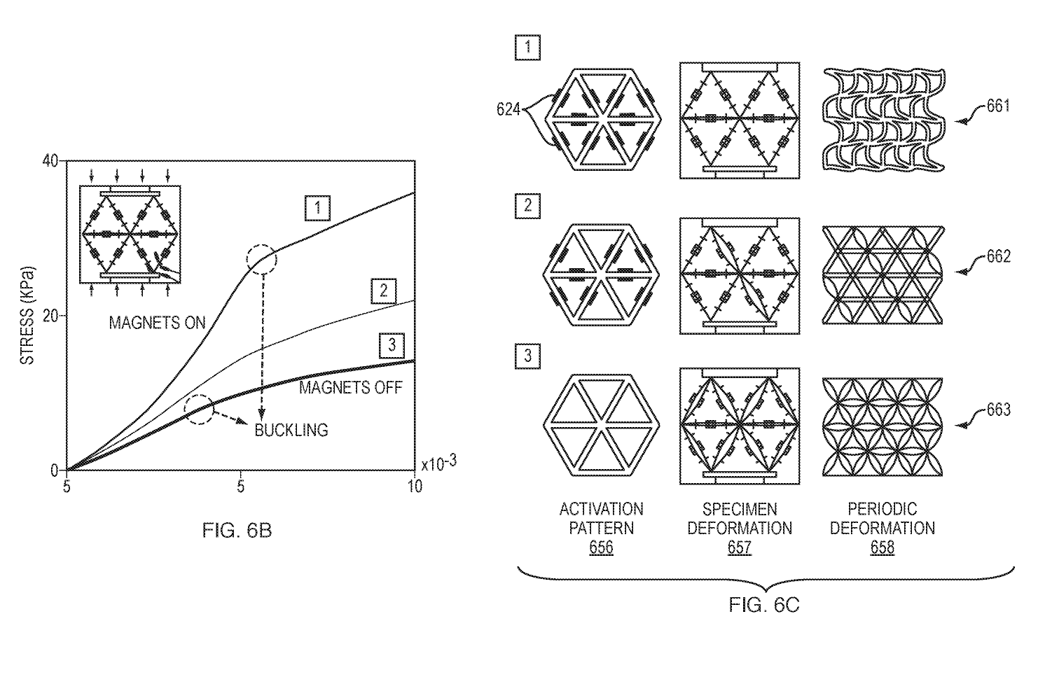

FIGS. 6A-6C illustrate lattice materials with a programmable nonlinear elastic response. FIG. 6A shows a schematic of an embodiment (600a) triangular lattice material, where each switchable link (620a) is bi-layer (FIG. 6B; 628a, 628b) and each layer is equipped with an electromagnet (624), for example, in the center (red) and is covered on the outer surface with compression blocks (626) (green). Each cell wall (627) includes the two adjacent walls (628a, 628b) with electromagnets (624) between them that resist separation by mutual attraction in the activated mode. Each wall (627) is also covered by u-shaped compression blocks (626), stacked only along its outer side with very small spacing. The compression blocks (626) give a cell wall (627) one-sided bending stiffness, so the cell wall (627) can buckle and bulge outward (i.e., toward the covered side) more easily than it can do inward. The area moments of inertia of the cell wall (627) in the outward and inward directions are denoted by Iₒᵤₜ and Iᵢₙ, (Iᵢₙ>Iₒᵤₜ).

FIG. 6B is a graph of a stress-strain response of a finite prototype structure with Iᵢₙ/Iₒᵤₜ=12, compressed along y, for various electromagnet activation patterns.

FIG. 6C is a graphic of electromagnet activation patterns (656) for different curves plotted in FIG. 6B, with the activated electromagnets (624) shown in red. The corresponding deformed shapes (657) for finite specimens are shown in the middle pictures at strain of 0.01. Images on right show the idealized deformed shapes (658) of infinite periodic structures for each electromagnet activation pattern (656). For an idealized infinite periodic structures, when all the electromagnets (624) are activated (case 1) (661), the lattice material buckles into a centrosymmetric pattern. When all the electromagnets are deactivated (case 3) (663), the buckling shape becomes anti-chiral. Any activation pattern between these two states results in an intermediate response, such as case 2 (662).

When the embodiment shown in FIG. 6A is compressed vertically, the oblique cell walls (627) become subject to axial compression forces. When electromagnets are deactivated, the slender walls (627) are able to buckle outward at low axial force, and the structure (600a) develops a geometrical pattern with six-fold floral symmetry, see FIG. 6C. However, when all electromagnets are activated, axial buckling of the cell walls (627) is suppressed, and the lattice material buckles at a higher load into an anti-chiral pattern observed in a regular triangular grid (see Haghpanah, B., et al., Buckling of regular, chiral and hierarchical honeycombs under a general macroscopic stress state, Proceedings of the Royal Society A: Mathematical, Physical and Engineering Science, 2014, 470(2167): p. 20130856). The stress corresponding to the onset of instability for the anti-chiral pattern is approximately 3.38 higher than that of floral pattern. This is consistent with the theoretical prediction for the ratio of buckling strength of the periodic structure in the chiral (σ₀) and symmetric (σ₁) modes,

$$\frac{{σ}_{0}}{{σ}_{1}} = \frac{1}{4} ( 1 + \frac{{I}_{in}}{{I}_{out}} ) = 3.25 .$$

Any activation pattern between these two states results in an intermediate response, such as case 2 (662) illustrated in FIG. 6C. Note that the triangular structure should ideally have a unique linear elastic response. However, a pre-buckling response of the structure is not unique and is dependent on the pattern of electromagnet actuation. This reliance of small-deformation response on the electromagnet activation pattern could be attributed to the initial curvature of the cell walls (627), primarily due to the weight of the electromagnets, which is ameliorated by activation of the electromagnets.

Despite possessing selectivity on a wide variety of buckling patterns, the example embodiment (600a) offers limited mode switch-ability. For instance, a switch from the floral mode to the unbuckled lattice shape is only possible at very small post-buckling deformations with minimal separation of the two cell wall layers (628a, 628b) where the electromagnets can effectively attract each other. The switch from the anti-chiral deformation to the floral deformation is only possible at strains smaller than ε<0.02. Passing this level of compression, excessive bending in the cell walls causes a geometric ‘lock’ of the anti-chiral post-buckling deformation and prevent any mode change due to magnet de-activation.

Triangular Lattice Material with Programmable Nonlinear Elastic Response

The following is a detailed derivation of the closed-form solutions for the buckling strength of the triangular lattice (embodiment 600a) with programmable nonlinear response, as presented above and shown in FIG. 6A. The embodiment (600a) is subjected to compressive stress along y, and a chiral and a symmetric mode of buckling are observed when the electromagnets are activated and deactivated, respectively. For the chiral pattern, the critical internal reaction force inside the oblique cell walls (walls making a 120° angle with the horizontal line) in a regular triangular grid can be obtained as described in Gandhi, F. and S.-G. Kang, Beams with controllable flexural stiffness, in The 14th International Symposium on: Smart Structures and Materials & Nondestructive Evaluation and Health Monitoring, 2007, International Society for Optics and Photonics:

$$F = \frac{{( 1.421 )}^{2} {π}^{2} EI}{{L}^{2}} \qquad ( D 1 )$$

where E is the Young's modulus of the cell wall (610) material, L is the edge length of the cell walls (627), and I is the bending rigidity of cell wall (610). For the embodiment (600a), each cell wall (627) includes two layers (628a, 628b) that can freely slide on each other, and each layer is covered with compression blocks (626) on the outer face. Therefore, I is defined as I=Iᵢₙ+Iₒᵤₜ, where Iᵢₙ and Iₒᵤₜ are respectively the bending rigidities of each individual layer when the cell wall (627) bends inward (compression blocks make contact) and outward (compression blocks do not make contact) with respect to the neutral axis of the bi-layer cell wall (627). Thus, Eq. (D1) can be rewritten as the following:

$${F}^{chiral} = \frac{{( 1.421 )}^{2} {π}^{2} E ( {I}_{in} + {I}_{out} )}{{L}^{2}} \qquad ( D2 )$$

For the symmetric mode, the buckling force at oblique walls can be obtained as the following:

$${F}^{symmetric} = \frac{{π}^{2} EI}{{( 0.5 L )}^{2}} \qquad ( D3 )$$

where 0.5 L is the effective length of a column with both ends fixed (clamped). For this mode of buckling, since both walls bend (buckle) outward, I=Iₒᵤₜ+Iₒᵤₜ=2Iₒᵤₜ. Then:

$${F}^{symmetric} = \frac{8 {π}^{2} {EI}_{out}}{{L}^{2}} \qquad ( D4 )$$

### Combining (D2) and (D4):

$$\frac{{F}^{chiral}}{{F}^{symmetric}} = \frac{1}{4} ( 1 + \frac{{I}_{in}}{{I}_{out}} ) \qquad ( D 5 )$$

Since the embodiment's (600a) response before the onset of stability is linear, the internal axial forces of the beam within the structure are proportional to the magnitude of applied macroscopic stresses. Therefore, the ratio of critical stresses for the chiral and anti-chiral buckling modes can be obtained as

$$\frac{{σ}^{chiral}}{{σ}^{symmetric}} = \frac{{F}^{chiral}}{{F}^{symmetric}} = \frac{1}{4} ( 1 + \frac{{I}_{in}}{{I}_{out}} ) .$$

Embodiments of the present invention provide programmable materials capable of real-time, significant adjustment in their mechanical response. When combined with autonomous sensing and control strategies, these materials can be used in a new series of structural components with enhanced static and dynamic efficiency. The real-time adjustment of the strut connectivity within a lattice is an effective way of achieving this goal. The use of lattices as the basis material has the additional benefit of yielding lightweight building materials for a diverse set of applications that impose significant penalties on mass. In the current disclosure, the adjustment of strut connectivity is achieved via electromagnetic interactions inside the cellular solid. Reducing the size of electromagnets, which is generally associated with a more significant reduction in the electromagnetic efficiency, remains a significant hurdle towards reducing the cell size of the material in order to obtain such capability in micro- and nano-architected materials.

Square Lattice Material with Programmable Young's Modulus

FIGS. 7A-7B illustrate an embodiment (700a), similar to embodiment (400a) illustrated in FIG. 4A, having a square lattice structure with programmable elastic response subjected to uniaxial loading. FIG. 7A is a schematic of the embodiment (700a) under uniaxial y loading and introduces the geometrical and material parameters. The embodiment (700a) has macroscopically orthotropic material properties since it has two mutually orthogonal twofold axes of symmetry.

In the most general case, a 2D orthotropic material is described by 5 dependent elastic moduli (i.e., Eₓ, E_{y}, G_{xy}, v_{xy} and v_{yx}). The embodiment (700a), however, has equal moduli in x and y if all electromagnets are in the same state, and different moduli if horizontal electromagnets are in a different state from vertical electromagnets. Here, an analytical approach based on strain energy is used to determine closed-form expressions for the effective in-plane orthotropic elastic moduli (i.e., Young's modulus and shear modulus) of the embodiment (700a) structure in x and y directions for different electromagnet activation patterns. In calculation of strain energy, only the terms resulting from the bending moments and axial loads in the beams are considered, and the shear strain energy stored in beams is neglected. This square-based structure has zero Poisson's ratio, regardless of electromagnet state.

To find the effective Young's modulus of the structure in material principal directions (i.e., x and y), a compressive far-field normal stress, σ_{yy}, in they direction is imposed. Next, the unit cell (710) (or primitive cell) of the structure is analytically analyzed by assembling and recreating the undeformed geometrical and loading patterns in the tessellated structure. The geometrical characteristics of the unit cell (710), as well as the tensile and bending properties of different beams inside the unit cell, are illustrated in FIG. 7A. The free body diagrams (FBDs) of the unit cell (710) and the unit cell internal loads and moments for two cases, where all the electromagnets are inactive (OFF) (721″) and active (ON) (721) are shown in FIG. 7B. The compressive force acting on unit cells (710) ends, F, can be calculated as a function of the applied normal stress as F=2(L₁ cos θ+L₂)σ_{yy}. When the electromagnets are deactivated (Off) (720′), the strain energy stored in the unit cell (710) can be written as a function of the compressive force, F, and the unknown moment, M, as U=U(F, M). Next, for the internal moment, M, ∂U/∂M=0 due to the reflection symmetry about the x axis of both the structure and loading. This condition can be used to obtain M as a function of F as M=−¼ FL₁ sin θ. The strain energy of the unit cell (710) can therefore be expressed as a function of F only. δ_{yy}^{off}=∂U/∂F gives the total contraction of the unit cell (710) in they direction as:

$${δ}_{yy}^{Off} = F ( \frac{2}{{E}_{2} ( \frac{{t}_{2}}{{L}_{2}} )} + \frac{{cos}^{2} θ}{{E}_{1} ( \frac{{t}_{1}}{{L}_{1}} )} + \frac{{sin}^{2} θ}{{{E}_{1} ( \frac{{t}_{1}}{{L}_{1}} )}^{3}} ) \qquad ( A 1 )$$

where the superscript index “Off” stands for inactive electromagnets (721″). The average strain of the unit cell (710) in they direction is given by the relation ε_{yy}^{off}=δ_{yy}^{off}/2(L₁ cos θ+L₂). The effective Young's modulus of the structure is defined as the ratio of the average stress, σ_{yy}, and the average strain, ε_{yy}^{off}, and obtained as:

$${E}^{Off} = {( \frac{2}{{E}_{2} ( \frac{{t}_{2}}{{L}_{2}} )} + \frac{{cos}^{2} θ}{{E}_{1} ( \frac{{t}_{1}}{{L}_{1}} )} + \frac{{sin}^{2} θ}{{{E}_{1} ( \frac{{t}_{1}}{{L}_{1}} )}^{3}} )}^{- 1} \qquad ( A 2 )$$

In this equation, describing the effective Young's modulus of the structure when the electromagnets are deactivated (721″), the dominant component is the bending term characterized by the (t/L)³ factor. When the beam relative thickness is small (i.e. t₁/L₁<0.01), the other components corresponding to the contribution of axial loads on the strain energy (characterized by factor t/L) can be ignored with less than 3% error.

Next, when the electromagnets are activated (ON) (721′), the strain energy stored in the unit cell (710) can be written as a function of the compressive force, F, the unknown force, P, and the unknown moment, M, as U=U(F, P, M). For the redundant internal force and moment, P and M, we have ∂U/∂P=0 and ∂U/∂M=0, which are employed to obtain P=m₁F and M=n₁L₁F, where the coefficients m₁ and n₁ are given as:

$$\begin{matrix}{m}_{1} = ( \frac{sin θcos θ}{2 {E}_{1}} ) ( \frac{1}{{( \frac{{t}_{1}}{{L}_{1}} )}^{3}} - \frac{1}{( \frac{{t}_{1}}{{L}_{1}} )} ) / ( \frac{2 sin θ}{{E}_{3} ( \frac{{t}_{3}}{{L}_{1}} )} + \frac{{sin}^{2} θ}{{E}_{1} ( \frac{{t}_{1}}{{L}_{1}} )} + \frac{{cos}^{2} θ}{{{E}_{1} ( \frac{{t}_{1}}{{L}_{1}} )}^{3}} ) & ( A 3 a ) \\ {n}_{1} = 0.5 ( {m}_{1} cos θ - 0.5 sin θ ) & ( A 3 b )\end{matrix}$$

The strain energy of the unit cell can therefore be expressed as a function of F only. δ_{yy}^{on}=∂U/∂F gives the total contraction of the unit cell (710) in they direction as:

$${δ}_{yy}^{On} = F ( \frac{2}{{E}_{2} ( \frac{{t}_{2}}{{L}_{2}} )} + \frac{8 {m}_{1}^{2} sin θ}{{E}_{3} ( \frac{{t}_{3}}{{L}_{1}} )} + \frac{4}{{E}_{1} ( \frac{{t}_{1}}{{L}_{1}} )} {( {m}_{1} sin θ + 0.5 cos θ )}^{2} + \frac{16 {n}_{1}^{2}}{{{E}_{1} ( \frac{{t}_{1}}{{L}_{1}} )}^{3}} ) \qquad ( A 4 )$$

where the superscript index “On” stands for active electromagnets (720). The average strain of the unit cell (710) in they direction is given by the relation ε_{yy}^{On}=δ_{yy}^{On}/2 (L₁ cos θ+L₂). The effective Young's modulus of the structure is defined as the ratio of the average stress, σ_{yy}, and the average strain, ε_{yy}^{On}, and obtained as:

$${E}^{On} = {( \frac{2}{{E}_{2} ( \frac{{t}_{2}}{{L}_{2}} )} + \frac{8 {m}_{1}^{2} sin θ}{{E}_{3} ( \frac{{t}_{3}}{{L}_{1}} )} + \frac{4}{{E}_{1} ( \frac{{t}_{1}}{{L}_{1}} )} {( {m}_{1} sin θ + 0.5 cos θ )}^{2} + \frac{16 {n}_{1}^{2}}{{{E}_{1} ( \frac{{t}_{1}}{{L}_{1}} )}^{3}} )}^{- 1} \qquad ( A 5 )$$

In this equation, describing the effective Young's modulus of the structure when the electromagnets are ON (721′), the dominant component is the stretching term characterized by the

$$( \frac{t}{L} )$$

factor (note that n₁ approaches zero when t₁/L₁ is small). Therefore, the structure behavior is said to be stretching dominated.

In a case where beams of type 2 have small length (i.e., L₂/L₁ <<1) and the remaining beams in the structure have a uniform and small thickness (i.e., t₁ /L₁=t₃/L₁ <<1), the stiffness of the structure can be expressed as

$${E}_{0} = \frac{{Et}^{3}}{{L}^{3} {sin}^{2} θ} and {E}_{1} = \frac{{Et cos}^{2} θ}{L ( 1 + 2 {sin}^{3} θ )} ,$$

respectively for inactive (720′) and active states (720).

Using the same analysis as above, the effective shear modulus of the structure under xy shear loading, G_{xy}, when all the electromagnets are deactivated (721″) and activated (721′) are obtained as:

$$\begin{matrix}{G}_{xy}^{Off} = 0.5 {( \frac{{sin}^{2} θ}{{E}_{1} ( \frac{{t}_{1}}{{L}_{1}} )} + \frac{4 {cos}^{2} θ}{{{E}_{1} ( \frac{{t}_{1}}{{L}_{1}} )}^{3}} + \frac{24 {cos}^{2} θ}{{E}_{2} ( \frac{{t}_{2}^{3}}{{L}_{1}^{2} {L}_{2}} )} + \frac{24 cos θ}{{E}_{2} ( \frac{{t}_{2}^{3}}{{L}_{1} {L}_{2}^{2}} )} + \frac{8}{{{E}_{2} ( \frac{{t}_{2}}{{L}_{2}} )}^{3}} )}^{- 1} & ( A 6 ) \\ {G}_{xy}^{On} = 0.5 ( \frac{24 {cos}^{2} θ}{{E}_{2} ( \frac{{t}_{2}^{3}}{{L}_{1}^{2} {L}_{2}} )} + \frac{24 cos θ}{{E}_{2} ( \frac{{t}_{2}^{3}}{{L}_{1} {L}_{2}^{2}} )} + \frac{8}{{{E}_{2} ( \frac{{t}_{2}}{{L}_{2}} )}^{3}} + \frac{32 {m}_{2}^{2} {sin}^{3} θ}{{{E}_{3} ( \frac{{t}_{3}}{{L}_{2}} )}^{3}} ) + \frac{4}{{E}_{1} ( \frac{{t}_{1}}{{L}_{1}} )} {( 0.5 sin θ - {m}_{2} cos θ )}^{2} + \frac{12}{{{E}_{1} ( \frac{{t}_{1}}{{L}_{1}} )}^{3}} {( {cos}^{2} θ + \frac{4}{3} {( 0.5 cos θ + {m}_{2} sin θ )}^{2} - 2 cos θ ( 0.5 cos θ + {m}_{2} sin θ ) )}^{- 1} & ( A 7 ) \\ where & \\ {m}_{2} = ( \frac{sin θ cos θ}{2 {E}_{1}} ) ( \frac{1}{( \frac{{t}_{1}}{{L}_{1}} )} + \frac{2}{{( \frac{{t}_{1}}{{L}_{1}} )}^{3}} ) / ( \frac{8 {sin}^{3} θ}{{{E}_{3} ( \frac{{t}_{3}}{{L}_{1}} )}^{3}} + \frac{{cos}^{2} θ}{{E}_{1} ( \frac{{t}_{1}}{{L}_{1}} )} + \frac{4 {sin}^{2} θ}{{{E}_{1} ( \frac{{t}_{1}}{{L}_{1}} )}^{3}} ) & ( A 8 )\end{matrix}$$

For a structure with E₁=E₂=E₃=E, L₁=2L₂32 L, t₁=t₂=t₃=t, and θ=45° the ratio of shear modulus when all the electromagnets are activated (721′) and deactivated (721″) is equal to G_{xy}^{On}/G_{xy}^{off}≅1.016. In the same structure, the ratio of Young's modulus in those states is equal to

$${E}_{xy}^{On} / {E}_{xy}^{Off} = \frac{1}{2 ( 3 + \sqrt{2} ) {( t / L )}^{2}} ,$$

showing that activation of the electromagnets has a significant effect on the structures Young's modulus in the x and y directions (since the term (t/L)² appears in the denominator) but a less effect on the shearing modulus of the structure. This is due to the fact that under shear loading, the beams that are not part of the triangular frame (i.e., beams of length L₂) remain bending dominated even when the electromagnets are activated (721′).

Square Lattice Material with Programmable Poisson's Ratio

FIGS. 8A-8F show an embodiment (800a), similar to embodiment (400b) illustrated in FIG. 4D, with a programmable Poisson's ratio that has macroscopic properties that are dependent on the activation patterns of the electromagnets. In the case where sets (8110 of tunable elasticity units (i.e., unit cells) (810-1, 810-2) that are located in the vertical and horizontal directions each have uniform activation states (e.g., all vertical electromagnets are activated while all horizontal electromagnets are deactivated), the structure has a macroscopically orthotropic material properties (described by 5 moduli: Eₓ, E_{y}, G_{xy}, v_{xy} and v_{yx}), since it has two mutually orthogonal axes of reflection symmetry. Moreover, the embodiment (800a) has equal moduli in x and y if all the electromagnets are in the same activation state. In the case where the electromagnets are uniformly activated or deactivated, the mechanical response of the structure can be characterized by three moduli (e.g. E, G and v) for each electromagnet activation state. Here, an analytical approach based on strain energy was used to determine closed-form expressions for the effective in-plane orthotropic Poisson's ratio of the embodiment (800a). In the calculation of strain energy, only the terms resulting from the bending moments and axial loads in the beams are considered, and the shear strain energy stored in beams is neglected.

To find the effective Poisson's ratio of the structure (800a) in the material principal directions (i.e., v_{xy}), a compressive far-field normal stress, σ_{yy}, in they direction and also a compressive pseudo stress in the x direction are imposed. The grey rectangular area (811) is chosen as an analytical unit cell (i.e., primitive cell) (811) of the structure. This is the smallest structural unit within the structure, by assembling which undeformed geometrical and loading patterns in the tessellated structure are recreated. Note that the unit cell is divided into two sub-unit-cells (810-1 and 810-2) with each one being the result of a 90° rotation of the other one in the x-y plane. The geometrical characteristics of the unit cell (811) and the material elastic moduli of different beam types in the unit cell (811) are also illustrated in FIG. 8A.

FIGS. 8B and 8C illustrate the beam connectivity and also forces acting on the unit cell (811) of the structure in the cases where the electromagnets are OFF (821″) and ON (821′), respectively. The compressive force, F, acting on the unit cells (811) is given as a function of the applied stress as, F=2(L₁ cos θ+L₂)σ_{yy}. The pseudo force, P, is used to compute the total stretching of the sub-unit-cells (810-1 and 810-2) in the x direction. Note that since the effective areas for sub-unit-cells (810-1 and 810-2) are squares with same edge lengths, three geometrical parameters (here L₁, L₂ and θ) are sufficient to describe the topology of the structure.

$$\begin{matrix}{m}_{1} = ( \frac{sin θ cos θ}{2 {E}_{1}} ) ( \frac{1}{{( \frac{{t}_{1}}{{L}_{1}} )}^{3}} - \frac{1}{( \frac{{t}_{1}}{{L}_{1}} )} ) / ( \frac{2 sin θ }{{E}_{3} ( \frac{{t}_{3}}{{L}_{1}} )} + \frac{{sin}^{2} θ}{{E}_{1} ( \frac{{t}_{1}}{{L}_{1}} )} + \frac{{cos}^{2} θ}{{{E}_{1} ( \frac{{t}_{1}}{{L}_{1}} )}^{3}} ) & ( B 1 a ) \\ {n}_{1} = 0.5 ( {m}_{1} cos θ - 0.5 sin θ ) & ( B 1 b ) \\ {m}_{2} = ( \frac{sin θ}{{E}_{3} ( \frac{{t}_{3}}{{L}_{1}} )} ) / ( \frac{2 sin θ }{{E}_{3} ( \frac{{t}_{3}}{{L}_{1}} )} + \frac{{sin}^{2} θ}{{E}_{1} ( \frac{{t}_{1}}{{L}_{1}} )} + \frac{{cos}^{2} θ}{{{E}_{1} ( \frac{{t}_{1}}{{L}_{1}} )}^{3}} ) & ( B 1 c ) \\ {n}_{2} = - 0.5 {m}_{2} cos θ & ( B 1 d )\end{matrix}$$

The detailed free body diagram of the type 1 sub-unit-cell (810-1) for both activation modes (821′ and 821″) is shown in FIG. 8D. For a type 1 sub-unit-cell (810-1), the strain energy stored in the sub-unit-cell (810-1) can be written as a function of the compressive force, F, the pseudo force, P, the unknown force, Q, and the unknown moment, M, as U=U(F, P, Q, M). Next, for the redundant internal force Q and the redundant internal moment M, can be written as ∂U/∂Q=0 and ∂U/∂M=0. These are employed to obtain the unknown force and the unknown moment as functions of F and P as Q=m₂F−m₁P and M=(n₂F+n₁P)L₁, where the coefficients m₁, m₂, n₁, and n₂ are given below.

The strain energy of the sub-unit-cell (810-1) can then be expressed as a function of F and P only. δₓₓ¹=∂U/∂P|ₚ₌₀ gives the total stretching of the sub-unit-cell (810a) in the x direction as:

$${δ}_{xx}^{1} = F ( \frac{4 {m}_{1} ( 1 - 2 {m}_{2} ) sin θ}{{E}_{3} ( \frac{{t}_{3}}{{L}_{1}} )} - \frac{4 {m}_{2} sin θ}{{E}_{1} ( \frac{{t}_{1}}{{L}_{1}} )} ( {m}_{1} sin θ + 0.5 cos θ ) + \frac{16 {n}_{1} {n}_{2}}{{{E}_{1} ( \frac{{t}_{1}}{{L}_{1}} )}^{3}} ) \qquad ( B 2 )$$

Similarly, δ_{yy}¹=∂U/∂F|ₚ₌₀ gives the total contraction of the type 1 sub-unit-cell (810-1) in they direction as:

$${δ}_{yy}^{1} = F ( \frac{2}{{E}_{2} ( \frac{{t}_{2}}{{L}_{2}} )} + \frac{2 sin θ}{{E}_{3} ( \frac{{t}_{3}}{{L}_{1}} )} {( 1 - 2 {m}_{2} )}^{2} + \frac{4 {m}_{2}^{2} {sin}^{2} θ}{{E}_{1} ( \frac{{t}_{1}}{{L}_{1}} )} + \frac{16 {n}_{2}^{2}}{{{E}_{1} ( \frac{{t}_{1}}{{L}_{1}} )}^{3}} ) \qquad ( B 3 )$$

The free body diagrams for the type 2 sub-unit-cell (810-2) are shown in FIGS. 8E and 8F for the cases when all the electromagnets are inactive (OFF) (821″) and active (ON) (821′), respectively. The same approach is used to compute the total stretching of the type 2 sub-unit-cell (810-2) in the x and y directions in the two activation states. The total stretching of the type 2 sub-unit-cell (810-2) in the x and directions is obtained respectively as:

$$\begin{matrix} {δ}_{xx}^{2 - Off} = \frac{F sin θ cos θ}{{E}_{1}} ( \frac{1}{{( \frac{{t}_{1}}{{L}_{1}} )}^{3}} - \frac{1}{( \frac{{t}_{1}}{{L}_{1}} )} ) & ( B 4 a ) \\ {δ}_{xx}^{2 - On} = {δ}_{xx}^{1} & ( B 4 b ) \\ {δ}_{xx}^{2 - Off} = F ( \frac{2}{{E}_{2} ( \frac{{t}_{2}}{{L}_{2}} )} + \frac{{cos}^{2} θ}{{E}_{1} ( \frac{{t}_{1}}{{L}_{1}} )} + \frac{{sin}^{2} θ}{{{E}_{1} ( \frac{{t}_{1}}{{L}_{1}} )}^{3}} ) & ( B 4 c ) \\ {δ}_{xx}^{2 - On} = F ( \frac{2}{{E}_{2} ( \frac{{t}_{2}}{{L}_{2} - {L}_{1} sin θ + {L}_{1} cos θ} )} + \frac{8 {m}_{1}^{2} {sin}^{2} θ}{{E}_{3} ( \frac{{t}_{3}}{{L}_{1}} )} + \frac{4}{{E}_{1} ( \frac{{t}_{1}}{{L}_{1}} )} {( {m}_{1} sin θ + 0.5 cos θ )}^{2} + \frac{16 {n}_{1}^{2}}{{{E}_{1} ( \frac{{t}_{1}}{{L}_{1}} )}^{3}} ) & ( B 4 d )\end{matrix}$$

where the superscript indices 2-Off and 2-On correspond to the type 2 sub-unit-cell (810-2) when all the electromagnets are OFF (821″) and ON (821′). Note that Eq. (B4b) is a demonstration of Maxwell-Betti reciprocal work theorem (see Wachtman Jr, J., et al., Exponential temperature dependence of Young's modulus for several oxides, Physical Review, 1961, 122(6): p. 1754). The effective Poisson's ratio of the unit cell (811) is obtained as v_{xy}^{off}=(δₓₓ¹+δₓₓ^{2-off})/(δ_{yy}¹+δ_{yy}^{2-off}) and v_{xy}^{on}=(δₓₓ¹+δₓₓ^{2-on})/(δ_{yy}¹+δ_{yy}^{2-on}), respectively, for OFF (821″) and ON (821′) actuation modes. For θ=45°, L₂=0 and uniform thickness and stiffness of beam types 1 and 3, the effective Poisson's ratio for the periodic structure, v_{xy}, can be expressed as ˜1 (i.e., nearly incompressible) and \sqrt{2}/(1+(a/L)) in modes 0 and 1 of actuation, respectively.

Collinear Locking Mechanism

A schematic of a structural unit cell (910) for programmable lattice materials containing a collinear locking mechanism (924) is shown in FIG. 9A. Unlike the simple unit cell (410) shown in FIG. 4B, which involves a normal contact between two electromagnets (shown in red) and provides two modes of ON (421′) and OFF (421″), the collinear locking mechanism (924) offers three different response modes, namely ON (921′), OFF (921″) and constant force (CF) (921′″), where, in the CF mode (921′″), the extension or contraction of the two horizontal bars is allowed at a constant, non-zero, internal tensile or compressive force, respectively. In the CF mode (921′″), the vertical force applied at the unit cell's two ends causes the unit cell (910) to deform elastically. Assuming small deformations, the slope of force-displacement response (and also stress-strain) for the unit cell (910) is equal to that in the OFF mode (921″), and the unit cell (910) has a bending-dominated response. However, the extension of force-displacement line does not necessarily pass through the origin.

FIG. 9B shows the working principle of the collinear locking mechanism (924). In this embodiment, an electromagnet (972) is located between a left metallic bar (L) on the bottom and a 3D printed triangular prism (974) with tip half-angle of θ on the top. A right bar (R) is placed underneath the left metallic bar (L) to which a frame is attached as shown in FIG. 9B. A v-shaped notch on the upper surface of the electromagnet (972) and a wide groove on the lower surface of the upper frame plate hold the triangular prism (974) in place. Assuming the right bar (R) to be mechanically grounded and the electromagnet (972) to be on, the magnet sticks to the left bar (L) and tries to follow it, slightly rotating the triangular prism (974). After a small amount of motion, this rotation causes the metal bar (L) to press against the right bar (R) and exert a normal force component on the electromagnet (972), which increases its contact force against the left bar (L). This effect can significantly increase the holding force of the collinear locking mechanism (924) through increased friction force.

FIG. 9C includes free body diagrams of the triangular prism (974) and the metallic bar (L). Force Fₜ with angle θ from the vertical line is exerted from the lower tip of the triangular prism (974) on the electromagnet (972). Note that the rotated triangular prism (974) is statically a two force member, and, therefore, an internal net force transmitted through the triangular prism (974), Fₜ, is essentially along the side of the rectangle that connects the two contact points on top and bottom. Forces N and N* are the electromagnetic and contact forces between the electromagnet (972) and metallic bar (L) (the weight of the electromagnet is neglected). Force N** is the contact force between the metal plate (L) and the frames lower surface. The friction force between the electromagnet (972) lower surface and metallic bar (L) is denoted by F*_{f}. The friction force between the electromagnet (972) lower surface and metallic bar (L) is denoted by F**_{f}. The following set of equations describe the statics of the problem (force Fₛ which is exerted from the regulating screw is considered later):

F*_{f}=μ*N* (C1a)

F*_{f}=Fₜ sin θ (C1b)

N*=N+Fₜ cos θ (C1c)

F**_{f}=μ**N** (C1d)

F_{cr}=F*_{f}+F**_{f} (C1e)

where μ* is the coefficient of friction between the metal plate (L) and the electromagnet (972) surface, and μ** is the coefficient of friction between the metal plate (L) and the frame lower surface. Combining these equations, the critical force that is needed for extension or contraction of the metallic plate (L) relative to the frame is obtained as:

$${F}_{cr} = \frac{μ * N}{1 - ( {μ}^{*} \text{/} tan θ )} ( 1 + {μ}^{**} \text{/} tan θ ) \qquad ( C 2 )$$

The above relationship implies that when the prism (974) tip half-angle θ is less than tan⁻¹μ*, the mechanism (974) is self-locking. However, when the half angle is chosen above this threshold, the mechanism's (924) holding force is a factor of (1+μ**/tan θ)/(1−(μ*/tan θ)) greater than a mechanism with no prism (i.e., based on shear friction between an electromagnet and a metal plate). Also, this implies a factor of μ*(1+μ**/tan θ)/(1−/tan θ)) improvement with respect to the mechanism (420a) shown in FIG. 4B, which is based on normal electromagnet contact.

A regulating screw (973) shown in FIG. 9B can be used to decrease a maximum holding force of the mechanism (974). This effect is achieved through an adjustment of the distance between the tip of the screw (973), which is held by the mechanism frame, and the electromagnet (972). When the tip of the screw (973) is close enough to the electromagnet (972), it comes into contact with the electromagnet (972) at a certain level of rotation of the triangular prism (974) and exerts a horizontal force Fₛ to the electromagnet (972) to hold it in horizontal equilibrium. This limits a maximum rotation of the prism (974) and, consequently, the mechanism (924) holding force. After the maximum holding force is reached, the linear locking mechanism (924) can continue to extend (or contract) at a fixed force. The value of the maximum holding force when the regulating screw (973) is in contact with the electromagnet (972) depends on material properties of the prism (974), electromagnet (972), and the frame, which is not analytically presented here.

FIG. 9D shows schematics of different modes of operation of the collinear locking mechanism (924) including relative extension or contraction at ON (921′), OFF (921″) and CF (921″') activation modes. In FIG. 9D, cases i and ii show the electromagnet (972) gripping the metal bar (L), and rotating the triangle (974) enough to lock the left bar (L) against the right bar (R) in extension or contraction, respectively. Cases iii and iv show the left bar (L) moving freely relative to the right bar (R) in extension or contraction, respectively. Cases v and vi show the regulating screw (973) coming into contact with the electromagnet (972) to limit the maximum rotation of the triangular prism (974) and, consequently, the mechanism (924) holding force.

The teachings of all patents, published applications, and references cited herein are incorporated by reference in their entirety.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus, comprising:
an array of one or more unit cells, formed from a material, each cell defining a shape; and
links coupled to the unit cells, at least a subset of the links enabling changing of an elasticity of at least a subset of the unit cells or at least a sub-array of the unit cells as a function of a state of the at least a subset of the links, the state including ON and OFF states.

2. The apparatus of claim 1, wherein the shape is a geometrical shape selected from two- or three-dimensional shapes that include at least one of the following: circle, sphere, oval, ellipse, ellipsoid, triangle, kagome, tetrahedron, pyramid, cone, square, cube, rectangle, cuboid, cylinder, rhombus, trapezoid, pentagon, hexagon, heptagon, octagon, octahedron, dodecahedron, or octet.

3. The apparatus of claim 1, wherein the material is one or more materials selected from polymers, plastics, ceramics, metals, metal oxides, metal alloys, cellular materials, foams, carbon fiber, biomaterials, or composites thereof.

4. The apparatus of claim 1, wherein:
a given link is an intra-connectivity coupled to at least two locations within a corresponding unit cell of the at least a subset of the unit cells; or
a given link is an inter-connectivity between or among unit cells within the at least a sub-array of the unit cells; and
a given link is fixed or switchable; and
a given link is defined as an intra-connectivity if coupled to at least two internal locations of a given unit cell, and a given link is defined as an inter-connectivity if coupled to an external location of at least two unit cells.

5. The apparatus of claim 1, wherein one or more of the links independently comprise a magnetic element, electro-static element, piezo-electric element, pneumatic element, hydraulic element, magneto-rheological element, electro-rheological element, photonically-sensitive element, phononically-sensitive element, or thermally-sensitive element.

6. The apparatus of claim 1, wherein the links are responsive to a duty cycle of ON and OFF states to provide a selectable dynamic level of elasticity of unit cells within the at least a subset of the unit cells or the at least a sub-array of the unit cells, wherein a period of the duty cycle has a frequency above a mechanical inertial bandwidth of the links to provide for a continuous range of intermediate states between the ON and OFF states.

7. The apparatus of claim 1, further comprising an excitation conducting element arranged in association with the material of the unit cells and configured to enable a stimulus to cause a state change of at least one of the links.

8. The apparatus of claim 7, wherein the excitation conducting element is an electron-conducting element, photon-conducting element, sound-wave conducting element, or heat-conducting element.

9. The apparatus of claim 1, further comprising an excitation source to provide a stimulus to:
at least one of the links, or
a wireless receiver coupled to at least one of the links, or
an excitation conducting element arranged in association with the material of the unit cells and configured to enable a state change of at least one of the links.

10. The apparatus of claim 9, wherein the excitation source includes at least one of the following: an electron-generator, photon-generator, sound-wave generator, heat source, or wireless-communications generator.

11. The apparatus of claim 9, further comprising a controller that activates the excitation source, and wherein the excitation source and controller are:
mechanically coupled to the array or a structure to which the array is coupled and communicatively coupled to the at least a subset of the links; or
communicatively coupled to the at least a subset of the links.

12. The apparatus of claim 11, wherein:
the controller is configured to control a switching array having switches operatively coupled to respective links, the switches effecting the ON and OFF states of the respective links; or
the controller is configured to control a power source to provide power to the links via the switches as a function of the ON and OFF states of the respective links.

13. A method, comprising:
stiffening and relaxing one or more links coupled to unit cells in an array of the unit cells to change elasticity of at least a subset of the unit cells or at least a sub-array of the unit cells, the unit cells formed from a material, each cell defining a shape, the stiffening and relaxing being a function of an ON state and an OFF state of the one or more links.

14. The method of claim 13, further comprising controlling the one or more links by configuring a switching array to provide a stimulus to the one or more links.

15. The method of claim 14, further comprising applying the stimulus, the stimulus being at least one of voltage, current, photonic signal, phononic signal, or heat.

16. The method of claim 13, wherein:
a given link is an intra-connectivity coupled to at least two locations within a corresponding unit cell of the at least a subset of the unit cells; or
a given link is an inter-connectivity between or among unit cells within the at least a sub-array of the unit cells; and
a given link is fixed or switchable; and
a given link is defined as an intra-connectivity if coupled to at least two internal locations of a given unit cell, and a given link is defined as an inter-connectivity if coupled to an external location of at least two unit cells.

17. The method of claim 13, wherein the one or more links independently comprise a magnetic element, electro-static element, piezo-electric element, pneumatic element, hydraulic element, magneto-rheological element, electro-rheological element, photonically-sensitive element, phononically-sensitive element, or thermally-sensitive element.

18. The method of claim 13, wherein the ON state and OFF state of the one or more links is controlled by an excitation conducting element arranged in association with the material of the unit cells and configured to enable a state change of the one or more links, the excitation conducting element being an electron-conducting element, photon-conducting element, sound-wave conducting element, or heat-conducting element.

19. The method of claim 13, further comprising applying a duty cycle of ON and OFF states to the one or more links, the one or more links being responsive to the duty cycle to provide a selectable dynamic level of elasticity of the at least a subset of the unit cells or the at least a sub-array of the unit cells, wherein a period of the duty cycle has a frequency above a mechanical inertial bandwidth of the one or more links to provide for a continuous range of intermediate states between the ON and OFF states.

20. An apparatus, comprising:
means for deforming one or more unit cells within an array or an arrangement of the one or more unit cells within the array; and
means for enabling or causing the deforming.
